(19) United States
(12) Patent Application Publication
(10) Pub. No.: US 2004/0020334 A1
(43) Pub. Date: Feb. 5, 2004

(54) Combination-tool for flush toilet lever and toilet seat

(76) Inventor: David A. Kish, Charlotte, NC (US)

Correspondence Address: DAVID A. KISH, 2905 RURAL HILL COURT, MATTHEWS, NC, 28105, US

(21) Appl. No.: 10/212,023

(22) Filed: Aug. 5, 2002

(51) Int. Cl. B25F 1/00

(52) U.S. Cl. 81/437

(57) ABSTRACT

A flat metal tool having on one end a screw driver tip for the purpose of tightening or removing toilet seat screws. On the other end of the tool is a cut out indentation used as a wrench to tighten or remove the toilet flush lever nut. The single piece tool is of stainless steel or a strong composite material that will not rust while it is stored in the toilet water tank.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION—FIELD OF INVENTION

This invention relates to specialty tools, specifically to such tools that repair flush toilets.

### BACKGROUND OF THE INVENTION

Most homes in the United States have flush toilets made in one basic design. There is a vast market for replacement parts. Replacement parts require tools to remove and install. Most ordinary tools used are inadequate.

Very frequently flush levers and toilet seats become loose and need tightening.

The flush lever has a large thin nut difficult to remove or tighten. This is because it is located in an awkward position for the average wrench or pliers.

Toilet seats require a large tipped screw driver to remove or or tighten the large head

### SUMMARY

In accordance with the present invention, a combination tool comprises a flat body of non-rusting metal material having a screw driver point on one end and a wrench opening on the other end.

### DRAWINGS—FIGURES

The combination tool is illustrated in its simplicity to point out its exceptional ease of use.

FIG. 1 shows the combination tool in actual size.

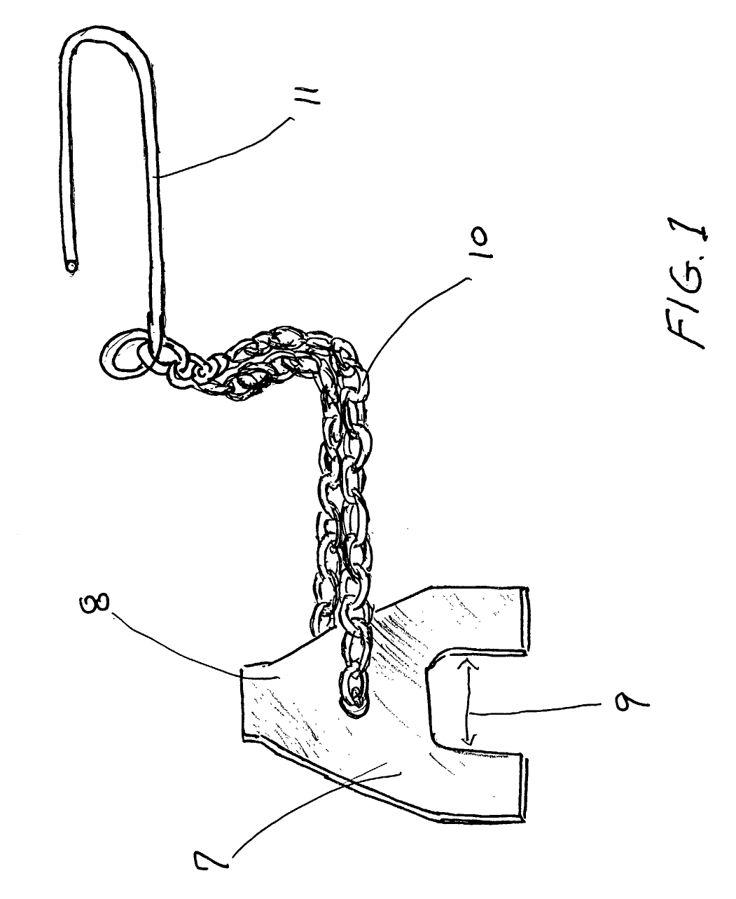

FIG. 2 shows the screwdriver end seated in a toilet seat screw.

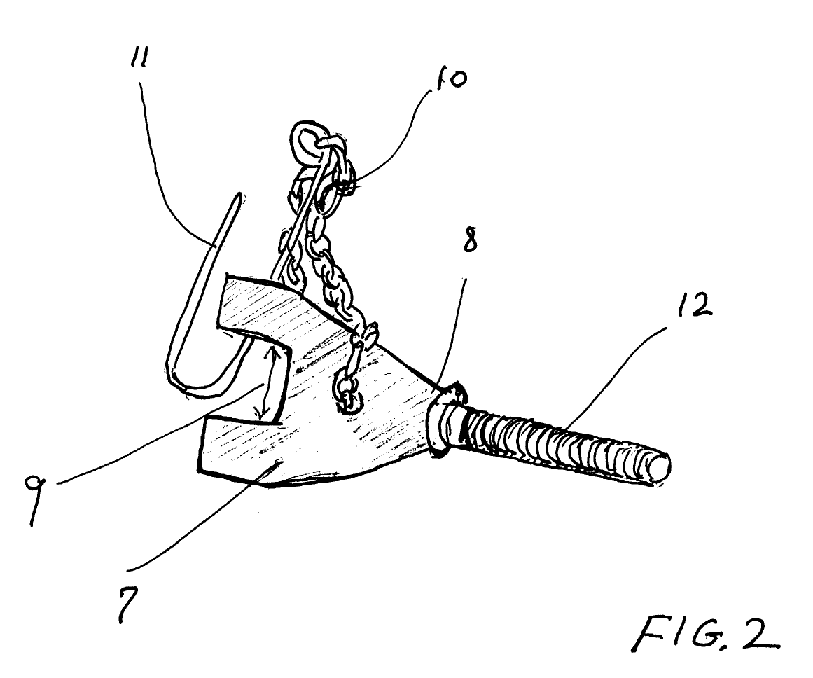

FIG. 3 shows the wrench end on a flush lever nut.

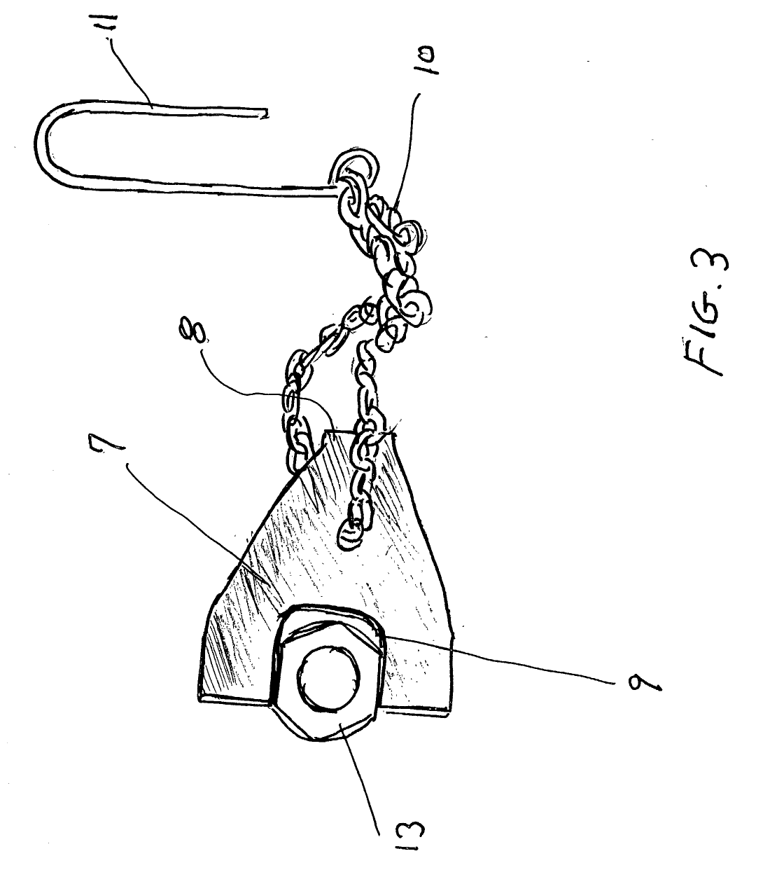

FIG. 4 shows the tool inserted in an installed toilet seat screw

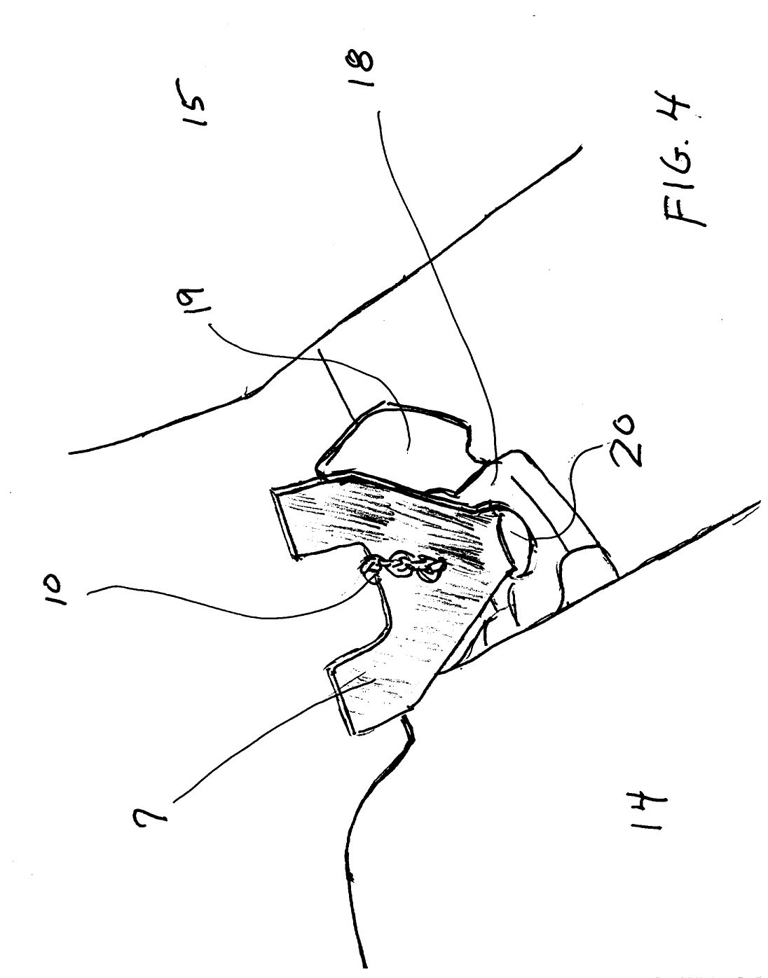

FIG. 5 shows the tool on an installed flush lever nut.

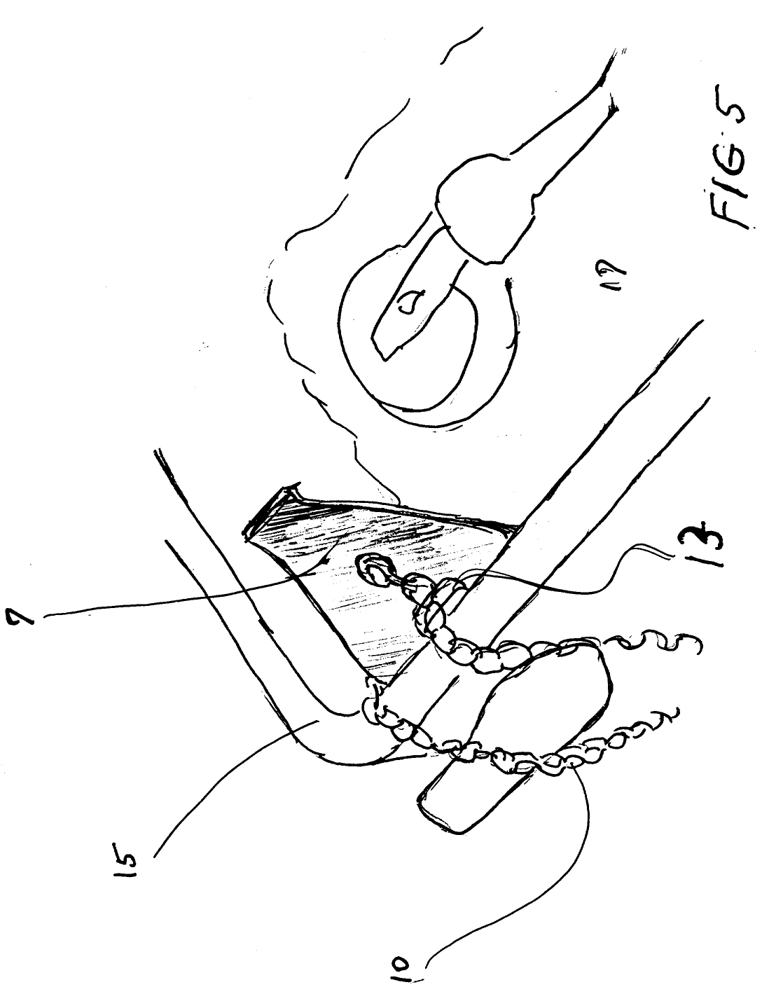

FIG. 6 shows the tool hanging in the water tank for illustration not actual size.

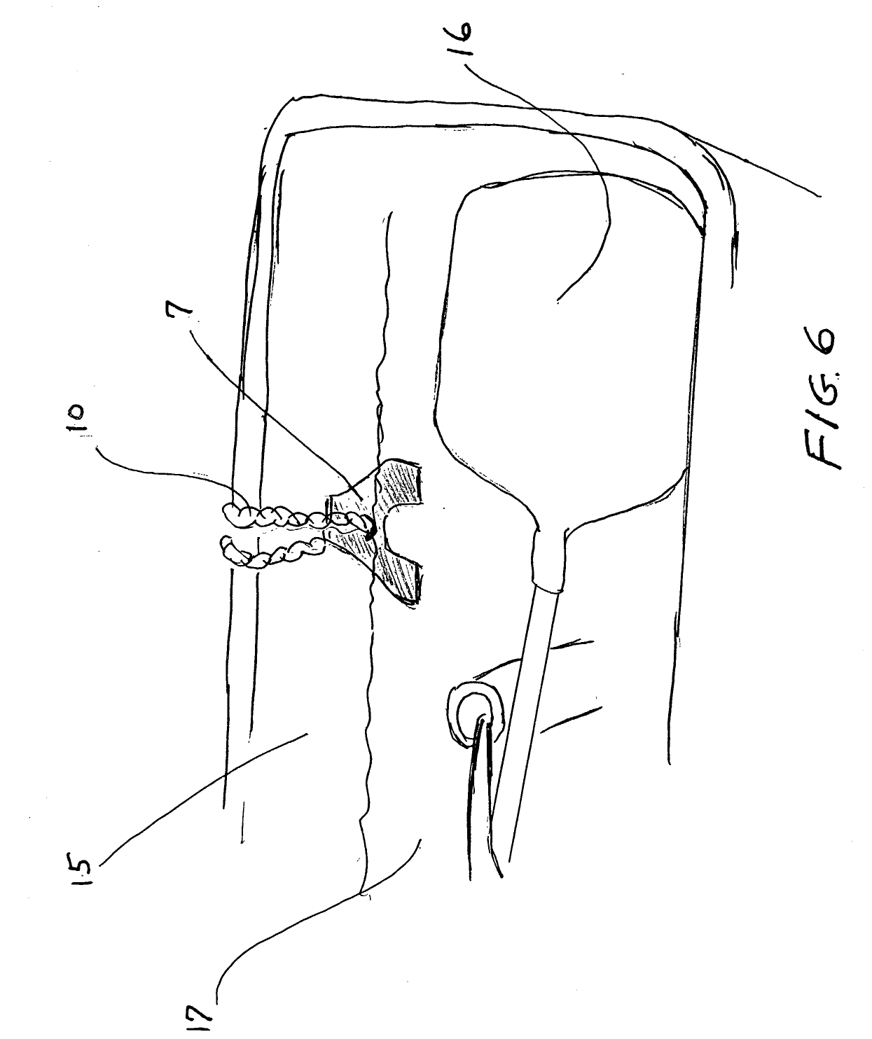

### DRAWINGS—REFERENCE NUMBERS

7 combination tool

8 screw driver end

9 wrench end opening

10 chain for hanging tool in tank

11 hook for hanging tool

12 toilet seat screw

13 flush lever nut

14 toilet seat lid

15 toilet water tank

16 toilet valve float

17 water in toilet tank

18 toilet seat screw flange

19 toilet seat screw flange cover flap

20 toilet seat screw in stalled

I claim:

1. A combination tool specifically designed and created for use in the tightening and or removal of toilet seat screws and the tightening and or removal of flush toilet lever nuts.

2. The combination tool in claim 1. Wherein said tool provides a simpler and easier method of doing these specific repairs and adjustments.

3. The combination tool in claim 1. Wherein the tool is made of non-rusting material to allow the storing of same tool in the toilet water tank for easy access.

4. The combination tool in claim 1. Wherein most common available screw drivers do not have a wide enough tip for the large size seat s crews. The combination tool has a wide screw tip designed for this particular purpose.

5. The combination tool in claim 1, where in most available wrenches are too wide or of too bulky construction for the thin large flush lever nut. The combination tool is sized specifically for the said nut for more effective handling.

6. The combination tool in claim 1, where in the size, shape and form of the combination tool is designed for ease of application and effective use.
